(19) United States
(12) Patent Application Publication
(10) Pub. No.: US 2008/0103804 A1
(43) Pub. Date: May 1, 2008

(54) COUNTRY ASSESSMENT

(75) Inventors: Jason Daniel Latta, Charlotte, NC (US); Lee James Hardee, Charlotte, NC (US); John P. Schelble, Charlotte, NC (US); Rahul Digamber Samant, Davidson, NC (US); Catherine Bates Ivey, Indian Trail, NC (US); Edward Charles Ritter, Charlotte, NC (US); Douglas Sean Hulse, Charlotte, NC (US); Avtar Singh Monga, DLF City Phase ll (IN); Eugene F. Rohrwasser, Mooresville, NC (US); Kellie L. McCorvey, Fort Mill, SC (US)

Correspondence Address: BANNER & WITCOFF, LTD;ATTORNEYS FOR CLIENT NUMBER 007131, 10 SOUTH WACKER DR., SUITE 3000, CHICAGO, IL, 60606, US

(73) Assignee: Bank of America, Charlotte, NC (US)

(21) Appl. No.: 11/923,186

(22) Filed: Oct. 24, 2007

Related U.S. Application Data
(60) Provisional application No. 60/863,781, filed on Oct. 31, 2006.

(51) Int. Cl. G06Q 10/00

(52) U.S. Cl. 705/1

(57) ABSTRACT

Systems and methods are disclosed for assessing a country as a relocation option. More specifically, a line of business may assess a country by generating a geographic model that may be based on data about a country. The system and method of generating a geographic model may include the generation of a reward score based on reward drivers may also generate a risk score that is based on risk factors. The reward score the risk score may be compared. The line of business may also conduct an in-country/due diligence visit based at least in part on the geographic model and may assemble a risk mitigation framework.

### RELATED APPLICATIONS

This application claims priority to U.S. Provisional Application No. 60/863,781 entitled “System and Method for Generating a Geographic Model,” which was filed on Oct. 31, 2006, and which is herein incorporated by reference in its entirety.

### FIELD OF THE INVENTION

Aspects of the disclosure relate to assessing a country as a relocation option. More specifically, aspects of the disclosure generate a geographic model for a country that is being assessed as a relocation option.

### BACKGROUND

Many business entities face increasing costs associated with managing, operating, and sustaining their business operations and managing their employees. A business entity may face difficulties in providing an employee with a competitive employment package. Typically, business entities must fiercely compete in their industry to provide attractive salaries and benefits to employees or the business entity will face low attrition rates and significant employee turnover. Many highly skilled employees and employees having unique skills may demand attractive employment packages.

Business entities have considered many solutions to improve employee attrition rates and decrease the financial strain of a competitive employee market. A typical American employee demands a high salary, good benefits, a good work environment, vacation time, and other job-related perks such as reimbursement for higher education. These job-related perks are expensive and may not be cost-effective for the business entity. A business entity is forced to commit significant resources to employ an American work force and may often find that the demands of American employees far exceed the allotted budget.

A business entity facing budget issues may choose to employ a work force from another location. The option to relocate may be considered by both American and many foreign countries, especially those countries having a high cost of living and a demanding work force. A line of business faces many risks to relocate a portion or its entire workforce, including investing significant capital, time, and personnel. Further, the business entity may also consider many relocation options and each option's characteristics before making the decision to relocate. The business entities often find that assessing a country as a relocation option is an arduous and risky task.

A method and system for assessing a country as a relocation option is needed. Further, a method and system of comparing a group of countries as a relocation option is also needed. The assessment of a country may include an analysis of the country's geographic considerations, risk factors, and the mitigation factors. The country assessment may also consider the specific needs of the business entity and may balance of risks and rewards that are associated with the relocation option.

### BRIEF SUMMARY OF THE INVENTION

Aspects of the present disclosure address one or more of the issues mentioned above by describing a system and method for assessing a country. The following presents a simplified summary of the disclosure in order to provide a basic understanding of some aspects of the systems and methods for assessing a country. It is not intended to identify key or critical elements of the invention nor is it intended to delineate the scope of the invention. The following summary merely presents some concepts of the disclosure in a simplified form as a prelude to the more detailed description provided below.

In one example in accordance with aspects of the disclosure, a method is illustrated for generating a geographic model. A country may be selected and country data relating to the country may be analyzed. At least one category that relates to the country may be generated. A reward score for the country may also be generated, where the reward score may be based at least in part on the country data and at least one category. A risk score may also be generated for the country. The risk score may be based at least in part on the country data and at least one category.

In another example in accordance with aspects of the disclosure, a method of assessing a country is illustrated. At least one country may be identified and a geographic model may be generated for the country. An in-country/due diligence visit may be conducted based at least in part on the geographic model. A risk mitigation framework may also be assembled that is based at least in part on the geographic model and the in-country/due diligence visit. A relocation country may be selected.

In yet another example in accordance with aspects of the invention, a computer-readable medium may comprise computer-executable instructions that perform a method. A country may be selected and country data relating to the country may be analyzed. At least one category that relates to the country may be generated. A reward score relating to the country may also be generated, where the reward score is based at least in part on the country data and the category. A risk score may be generated that relates to the country. The risk score may be based at least in part on the country data and the category.

In another example in accordance with aspects of the invention, an apparatus for generating a geographic model is illustrated. The apparatus may comprise a memory that stores a plurality of modules and a processor that is configured to execute the computer-executable instructions in the plurality of modules. The plurality of modules may comprise computer-executable instructions. The plurality of modules may include a country data module, a category module, a reward module, a risk module, and a comparison module. The country data module may be configured to store country data that relates to the country. The category module may be configured to identify categories on which to analyze the country. The reward module may be configured to calculate a reward score that may be based at least in part on the country data and the categories. The risk module may be configured to calculate a risk score that is based at least in part on the country data and the categories. The comparison module may be configured to compare the reward score and the risk score. The processor may be configured to execute the computer-executable instructions in the plurality of modules to generate the geographic model that may be based at least in part on the reward score and the risk score.

### BRIEF DESCRIPTION OF THE DRAWINGS

The present disclosure is illustrated by way of example and not limited in the accompanying figures in which like reference numerals indicate similar elements and in which:

FIG. 1 illustrates a computing device for implementing an embodiment of the invention.

FIG. 2 is a block diagram of a method for assessing a country, according to an aspect of the invention.

FIG. 3 is a flowchart of a method for generating a geographic model, in accordance with an aspect of the invention.

FIG. 4 is a flowchart illustrating a method for generating a geographic model and calculating a risk score and a reward score, according to an aspect of the invention.

FIG. 5 is a flowchart illustrating a method for calculating a risk score and a reward score, in accordance with an aspect of the invention.

### DETAILED DESCRIPTION

The country assessment relates to the assessment of offshore, near shore, and outsourcing relocation options for a line of business. Each country may be evaluated based on a geographic model that may be generated. The geographic model may include one or more risk factors and one or more reward drivers that may help to assess a country's value as a relocation option. Portions of the country assessment may be performed in a computer system. Moreover, the geographic model may be generated in a computer system.

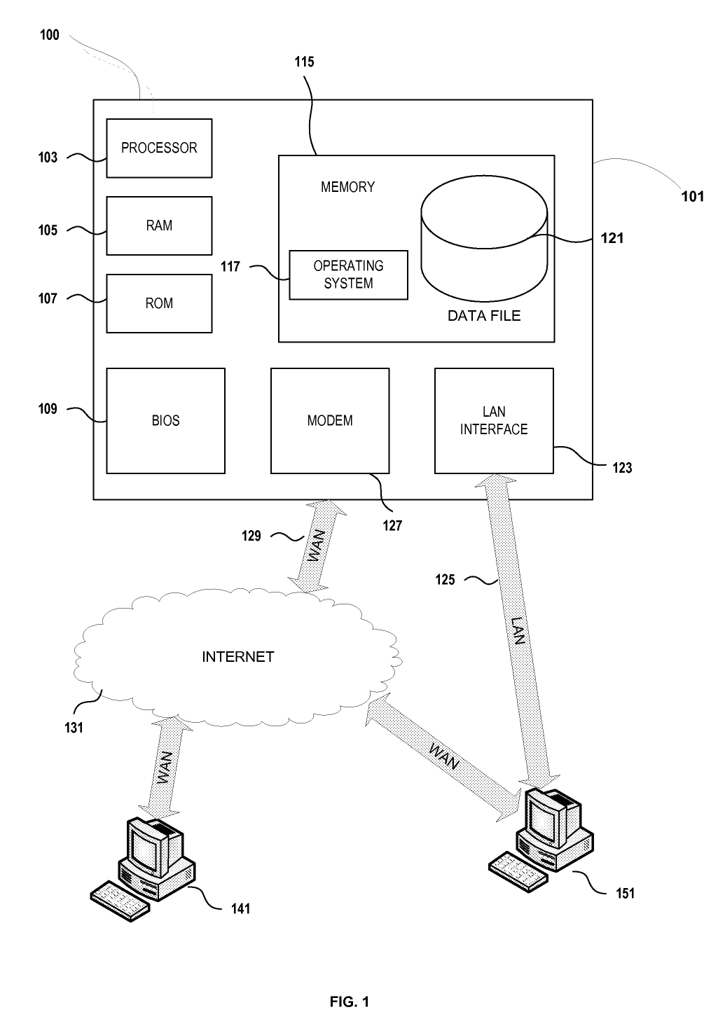

FIG. 1 illustrates an example of a computing system environment 100 that may be used according to one or more embodiments of the invention. The computing system environment 100 is only one example of a suitable computing environment and is not intended to suggest any limitation as to the scope of use or functionality of the invention. The computing system environment 100 should not be interpreted as having any dependency or requirement relating to any one or combination of the illustrated components.

The invention is operational with numerous other general purpose or special purpose computing system environments or configurations. Examples of well known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, etc. that perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices.

With reference to FIG. 1, the computing system environment 100 may include a computer 101 having a processor 103 for controlling overall operation of the computer 101 and its associated components, including RAM 105, ROM 107, an input/output module or BIOS 109, and a memory 115. The computer 101 typically includes a variety of computer readable media. The computer readable media may be any available media that may be accessed by the computer 101 and may include both volatile and nonvolatile media and removable and non-removable media. By way of example, and not limitation, computer readable media may comprise computer storage media and communication media.

Computer storage media may include volatile and nonvolatile and removable and non-removable media implemented in any method or technology for storage of information such as computer readable instructions, data structures, program modules, or other data. Computer storage media includes, but is not limited to, random access memory (RAM), read only memory (ROM), electronically erasable programmable read only memory (EEPROM), flash memory or other memory technology, CD-ROM, digital versatile disks (DVD) or other optical disk storage, magnetic cassettes, magnetic tape, magnetic disk storage or other magnetic storage devices, and any other medium that can be used to store the desired information and that can be accessed by the computer 101.

Communication media may embody computer readable instructions, data structures, program modules, and/or other data in a modulated data signal such as a carrier wave or other transport mechanism. It may also include any information delivery media. Modulated data signal is a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media. Although not shown, RAM 105 may include one or more applications representing the application data stored in RAM 105 while the computer is on and corresponding software applications (e.g., software tasks) are being executed.

The input/output module or BIOS 109 may include a microphone, keypad, touch screen, and/or stylus through which a user of the computer 101 may provide input. The input/output module or BIOS 109 may also include one or more of a speaker for providing audio output and a video display device for providing textual, audiovisual, and/or graphical output.

Software may be stored within memory 115 and/or storage to provide instructions to the processor 103 for enabling the computer 101 to perform various functions. For example, the memory 115 may store software used by the computer 101, such as an operating system 117 and an associated data file 121. Alternatively, some or all of the computer executable instructions for the computer 101 may be embodied in hardware or firmware (not shown). As described in detail below, the data file 121 may provide centralized storage of the country assessment and/or geographic model.

The computer 101 may operate in a networked environment that supports connections to one or more remote computers, such as computing devices 141 and 151. The computing devices 141 and 151 may be personal computers or servers that include many or all of the elements described above relative to the computer 101. The network connections depicted in FIG. 1 may include a local area network (LAN) 125 and a wide area network (WAN) 129 and may also include other networks. The computer 101 is connected to the LAN 125 through a network interface or adapter 123. The computer 101 may be a server and may include a modem 127 or other means for establishing communications over the WAN 129. For example, the computer 101 may connect to a WAN 129 such as the Internet 131 through a modem connection. The network connections may include any communications link between computers.

The existence of any of various well-known protocols such as TCP/IP, Ethernet, FTP, HTTP and the like is presumed, and the system can be operated in a client-server configuration to permit a user to retrieve web pages from a web-based server. Any of various conventional web browsers can be used to display and manipulate data on web pages.

Additionally, an application program may be used by the computer 101 according to an embodiment of the invention. The application program may include computer executable instructions for invoking user functionality related to communication, such as email, short message service (SMS), and voice input and speech recognition applications.

The computing devices 141 or 151 may also be mobile terminals including various other components, such as a battery, speaker, and antennas (not shown). The input/output module or BIOS 109 may include a user interface including such physical components as a voice interface, one or more arrow keys, joystick, data glove, mouse, roller ball, touch screen, or the like.

Each of the plurality of computing devices 141, 151 may contain software for creating a data file 121. The software may be a set of detailed computer-executable instructions for the computing devices 141, 151. The software may provide the computing devices 141, 151 with the ability to create a data file 121. The data file 121 may contain multiple individual files of information that may each correspond to an individual document. For example, if a plurality of countries are being assessed, then each country's assessment may be separately contained within the data file 121. Additionally, a report may be generated that includes information relating to one or more countries in the data file 121.

The computer 101 may include memory 115 for storing computer-readable instructions and a processor 103 for executing the computer-executable instructions. The computer-executable instructions may be data in the form of program source code that may be capable of modifying the data file 121. The computer-executable instructions may be a series or sequence of instructions for a computing device that is typically in the form of a programming language such as C++, Java, SQL, or the like. A person of ordinary skill in the art will appreciate that various computer programming languages may be used to create the computer-executable instructions, and the invention is not limited to the programming languages listed above.

The memory 115 may be a portion of the computer 101 that stores data or other instructions. The memory 115 may be retained or lost when power is lost to the system. The memory 115 may provide access to data for a user or computing device 141, 151 to revise and manage a data file 121. These and other aspects of the memory 115 will be apparent to one of ordinary skill in the art in view of the description below.

The processor 103 may be capable of executing the computer-executable instructions. The computer-executable instructions may be executed by the processor 103 after they have been stored in the memory 115. The processor 103 may be a centralized element within a computing system that is capable of performing computations. For example, the processor 103 may perform the computations that are described in the computer-executable instructions and then execute the computer-executable instructions. The computer-executable instructions may include data describing changes to the data file 121 that were made by a user or computing device 141, 151 over a computer network such as the Internet 131. The server 101 stores the data in the data file 121 that may be associated with a customer's account. The data file 121 may be stored in the memory 115 so that it may be accessible to a plurality of computing devices 141, 151 and/or users.

The data that is stored in the data file 121 may include country assessment information including a geographic model. The date file 121 may store any desired information, including contact information, general business information, financial information, and the like.

The country assessment data may be stored in the data file 121. Security precautions may be implemented to prevent unauthorized access to the data file 121. A user identification and a password may be required to access the data file 121 and/or the geographic model. Some of the data that is stored in the data file 121 may be shared between multiple lines of business. Any desirable security precautions may be implemented.

The computer-executable instructions may be a series or sequence of instructions for a computing device 141, 151, described in detail throughout this disclosure. The processor 103 may be configured to execute the computer-executable instructions that may be used to assess a country or countries. Such computer-executable instructions may be located (e.g., physically or logically) in modules in the memory 115. The computer network 131 may be any network that interconnects users and/or computing devices 141, 151. According to at least one aspect of the invention, the computer network 131 may provide shared access by two computing devices to at least a portion of the data in the plurality of modules. Shared access may be two or more computing devices 141, 151 that may be coupled to the computer network 131 and/or that may be able to communicate with each other and/or access, change, and add data to a data file 121.

A computer network such as the Internet 131 provides access to the date file 121 that may be shared between the computing devices 141, 151. Additionally, the computer network may be public or private and may be wired or wireless. The computing devices 141, 151 that are coupled to the computer network may be any electronic device that is capable of connecting to a computer network and transmitting data over the computer network. Further, the computing devices are capable of receiving data for entry into a data file 121 that may be associated with a country assessment.

Aspects of the invention have been described in terms of illustrative embodiments thereof. A person having ordinary skill in the art will appreciate that numerous additional embodiments, modifications, and variations may exist that remain within the scope and spirit of the appended claims. For example, one of ordinary skill in the art will appreciate that the steps illustrated in the figures may be performed in other than the recited order and that one or more steps illustrated may be optional. The methods and systems of the above-referenced embodiments may also include other additional elements, steps, computer-executable instructions, or computer-readable data structures. In this regard, other embodiments are disclosed herein as well that can be partially or wholly implemented on a computer-readable medium, for example, by storing computer-executable instructions or modules or by utilizing computer-readable data structures.

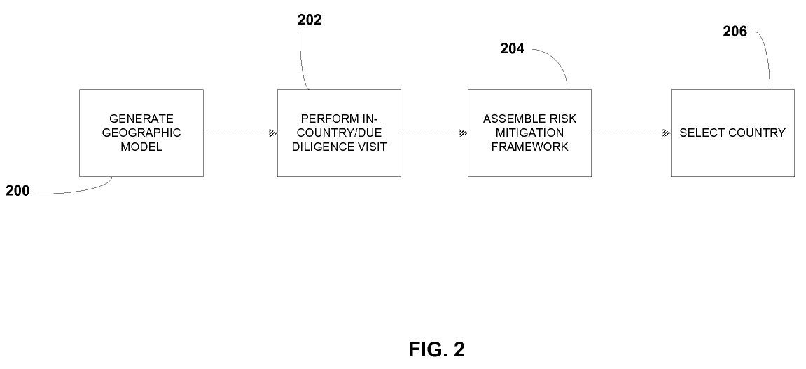

In reference to FIG. 2, a method of assessing a country is illustrated. The country assessment may generate a geographic model, at step 200. The geographic model may assess a relocation option for a line of business. The relocation option may include a country, city, time zone, and the like. The line of business may wish to assess more than one country as a relocation option (not shown). For example, a line of business may be considering relocating its operations to a Spanish-speaking country. The line of business may select Mexico and Spain as the countries it wishes to assess and may generate one geographic model for Mexico and another geographic model for Spain.

The country assessment may include performing an in-country/due diligence visit, as illustrated in step 202. The in-country/due diligence visit may be arranged to confirm that the location is suitable for the needs of the line of business. The in-country/due diligence visit may also be used as a tool to establish personal relationships with the local business community and government.

The in-country/due diligence visit may be an on-site visit by a representative of the line of business or a third party. It may include an analysis of the macro-environment, potential business partners, manufacturing logistics, site-specific analysis, and the like. The macro-environment may include meeting with government ministries, universities, and/or infrastructure providers. The in-country/due diligence visit may include meeting with entities in the private or public sector to establish business partners and relationships. The in-country/due diligence visit may also include conducting site reviews of existing or high potential strategic business and governmental concerns for the relocation option of the line of business.

The country assessment may assemble a risk mitigation framework, as in step 204. The risk mitigation framework may be assembled based on the industry in which the line of business operates and the personal assessments of objective and subjective factors that relate to relocating a line of business. Objective factors may be analyzed in the geographic model and subjective factors may be analyzed in the in-country/due diligence visit. The factors on which the risk mitigation framework may be assembled may be any factors of interest and the factors may be analyzed in the geographic model and/or in the in-country/due diligence visit.

The risk mitigation framework may include the identification of the risks for which the line of business will be responsible. The risks may include one or more lines of defense. Furthermore, the risk mitigation framework may also identify the risks for which a third party may be responsible for mitigating. Any risks may be considered in the risk mitigation framework.

The country assessment may include selecting a country, as shown in step 206. A country may be selected as a relocation option for offshore, near shore, and/or outsourcing needs of a line of business. The management of the line of business may be controlled by either internal sources or a third party. Oftentimes, a third party may be located locally in the selected country.

A country assessment may be periodically reviewed. For example, these decisions may be reviewed on a monthly, quarterly, and/or yearly basis. The decisions may also be reviewed on demand, such as when the needs or wishes of the line of business change.

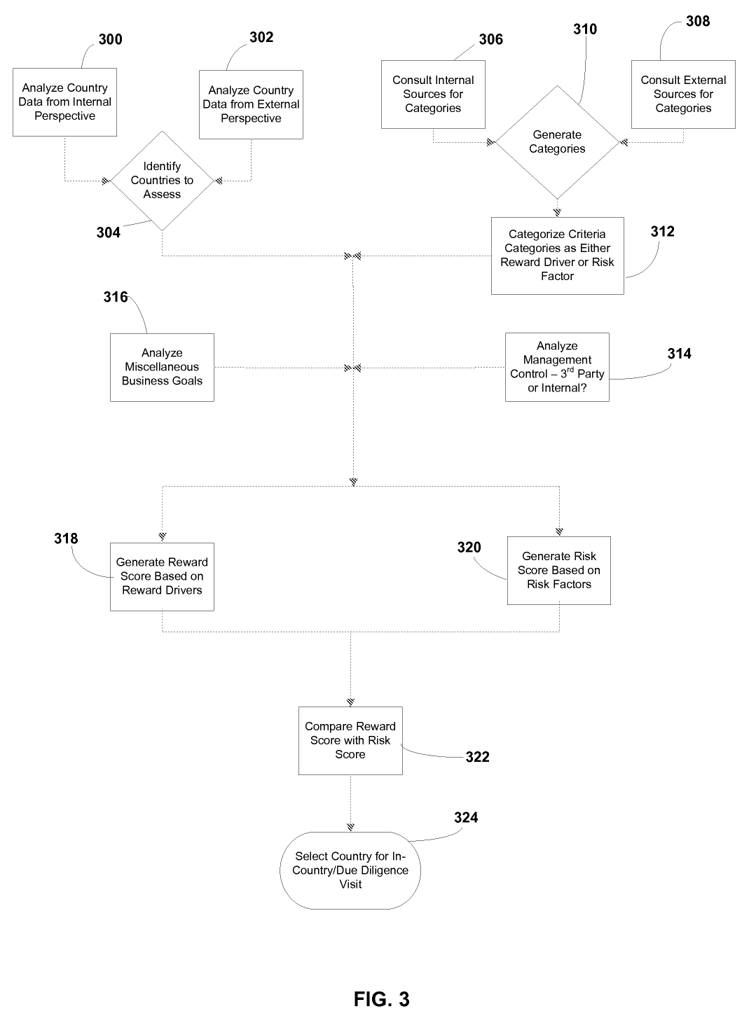

As illustrated in FIG. 3, the line of business may analyze country data from an internal perspective 300 and an external perspective 302 to identify one or more countries to assess 304. The internal perspective 300 may include management arrangements, budget analysis, personnel decisions, and the like. The external perspective 302 may include cultural integration issues, local government regulations, costs of production, and the like.

A line of business may consider several internal perspectives 300 including but not limited to, calculating an internal perspective score (not shown) that is at least part of the analysis of a relocation option. The internal perspective score may include data relating to internal concerns, considerations, and other subjective and/or objective data associated with the internal perspective 300 of a line of business. Further, the internal perspective score may include information relating to natural disasters or weather conditions of a relocation option such as hurricanes, typhoons, tsunamis, earthquakes, floods, tornados, and the like.

Many relocation options experience trends in weather and may suffer several consecutive years and/or seasons in which the weather is severe. For example, the Philippines may experience one typhoon during a first season and ten typhoons during a second season. The Philippines' internal perspective 300 may be negatively affected by the increased number of typhoons. The line of business may consider the internal perspective 300 without completely understanding the short, mid-range, and long term effects that the typhoons had on the Philippines and may refrain from investing and/or considering the Philippines as a relocation option as a result. Further, the line of business may also reconsider a relocation option in which it already invested resources and/or in which it already initiated manufacturing or operations and possibly lost confidence in its decision to proceed with analyzing a country as a relocation option.

Rather, the line of business may utilize the internal perspective 300 and/or other internal perspective information to mitigate the concerns associated with a decreased internal perspective 300 or a decrease in a rating that may be assigned to a relocation option that is at least partially based on the internal perspective 300. In the example described above, the Philippines' internal perspective 300 may be lower during the second year than during the first year due to the increased number of typhoons. Further, the Philippines may be assessed and may receive a rating that at least partially considers the internal perspective 300.

Because the Philippines' internal perspective 300 may have been negatively affected between the first season and the second season, a line of business may overlook the Philippines as a relocation option. A line of business may have decided to relocate its operations to the Philippines during the first season and may experience concern, apprehension, and the like during the second season when the Philippines' internal perspective 300 is negatively impacted. The internal perspective 300 may include information about the weather trends to mitigate concern and unnecessary retraction of resources when the weather trend is likely to end or improve.

In another example, the internal perspective 300 may consider a change in compensation costs for a relocation option. For instance, the average compensation costs for an information technology (IT) programmer in the Czech Republic may significantly increase from a first year to a second year, e.g., such as during the Czech Republic's economic transition from being associated with the Slovak Republic in 1992-1993, respectively. Such an increase in average compensation for an IT programmer may negatively affect the internal perspective for the relocation option, e.g., the viability of the country as a relocation option may decrease.

The internal perspective may consider the increase in average salary of an IT programmer over the tenure of several years or relative to increases in other viable countries that are being considered by the line of business as a relocation option. The internal perspective may include considerations of the stability of the country's economy, the country's employment opportunities, the ability of the country to provide employees educated in the desired industries, and the like in the analysis of the internal perspective. By including these additional perspectives, the internal perspective may provide a line of business with more comprehensive information during its consideration of a country as a relocation option when the country has experienced an increasing average salary for an important genre of employee, e.g., the IT programmers, as in the example above with the Czech Republic.

The external perspective 302 may include cultural integration issues, local government regulations, costs of production, and the like. A line of business may consider several external perspectives 302 including but not limited to, calculating an external perspective score (not shown) that is included in the analysis of a relocation option. Further, the external perspective 302 may be included in combination with the internal perspective 302 during an assessment of a country as a relocation option.

For example, a line of business may obtain information from a third party as an external perspective 302 relating to a country's risk information, such as historical weather information and a country's government stability rating. The line of business may rely upon the external perspective 302 and several internal perspectives 300, as described in detail above, during the assessment of a country as a relocation option. Additionally, the line of business may provide a third party with internal perspectives 300 and request that the third party prepare an external perspective 302 based upon the internal perspective 300 and independently generated information and/or information generated by considering the internal perspective 300. A line of business may consider any desired combination of internal perspectives 300 and external perspectives 302.

A line of business may wish to limit the number of countries it assesses. For example, a line of business may assess five countries for a project. The line of business may select the five countries based on prior knowledge and experience or any other subjective or objective consideration. Any desirable number of countries may be assessed.

One or more categories may be generated for each country 3 10. The categories may include information from internal sources 306 and information from external sources 308. Information from internal sources 306 may include prior knowledge and business relationships, internal research, and the like. Information from external sources 308 may be obtained from a variety of sources including, but not limited to, A. T. Kearney, Economist Intelligent Unite (EIU), Political Risk Services (PRS) Group, Watson Wyatt, Carnegie Mellon Software Engineering Institute, Customer Operations Performance Center (COPC), International Standards Organization (ISO), World Economic Forum, Gartner, International Monetary Fund (IMF), U.S. Census, United Nations Educational, Scientific, and Cultural Organization (UNESCO), Educational Testing Service (ETS), Country Profile Websites, Haut Conseil de la Francophonie, Clingendael International Energy Programme (CIEP), German Ministry of Foreign Affairs, TestDaF, World Bank, Transparency International, Program for International Student Assessment, Expedia, International Telecommunications Union, International Energy Agency, C B Richards Ellis, Business Software Alliance, Centre for Research on the Epidemiology of Disasters (CRED), and the like.

Information from the external sources 308 may be publicly known or may be generated under proprietary circumstances. For example, a line of business may be interested in assessing a group of countries and may choose to use only publicly available information or may choose to develop a relationship with one or several external sources. Both the internal and external sources' information may be used to generate categories that are tailored to the needs and goals of the line of business.

One or more categories may be categorized into risk factors and/or reward drivers 312. Each criterion may fall into one or both categories, as described in further detail below. The geographic model may include an analysis of the entity that will control at least a portion of the operations in the country being assessed 314. The management may be internally controlled or may be controlled by a third party. The management may be controlled locally or may be controlled remotely. The geographic model may include information relating to any other business goals of the line of business, as illustrated in step 316.

A reward score may be generated that may be partially or wholly based upon the reward drivers, as in step 318. Additionally, a risk score may be partially or wholly based upon the risk factors, as in step 320. The reward score and the risk score may be compared to one another in step 322. A country may be selected for an in-country/due diligence visit 324 based on the comparison of the reward score and the risk score. The reward score and the risk score may include subjective and objective information. Any desirable factors may be considered in determining the reward score and the risk score.

The reward score and risk score for a country may be compared over a period of time, e.g. from a first year to a second year. Any desired period of time may be used during this comparison such as quarters, fiscal years, billable years, decades, etc. The comparison of several reward scores over a period of time may be divided into categories to reflect the contribution of the change in each reward category, as compared to the total reward score, over the same period of time. Each category that is considered in the reward score may be tracked and compared over the same range of time or a different range of time, depending on the needs of the line of business. The comparison of the individual reward categories for one country may be compared to the comparison of the individual reward categories for a second country. A line of business may choose to apply a similar comparison process with the risk score and the individual risk categories as described above for the reward score and the individual reward categories, respectively.

A line of business may also consider the contribution of the change, e.g., to the overall reward score and/or risk score. A change may indicate a positive or negative feature of the country or may indicate instability within the country. Further, a change may appear negative in the calculation of the reward score and/or risk score, but may have long term positive effects. For example, a country may invest in building a sound technology infrastructure, which may cause the economy to be stimulated during a first period of time due to the high volume of manual labor that is required for constructing the networks. During a second period of time, the economy may slow down when the construction phase is complete because its workforce does not possess the educational skills that are necessary to perform jobs such as an IT programmer or other engineer that would be needed by a line of business. This phenomenon may or may not impact the decision of a line of business in relocating its operations to a country, depending on the country's resources that may be needed by of the line of business.

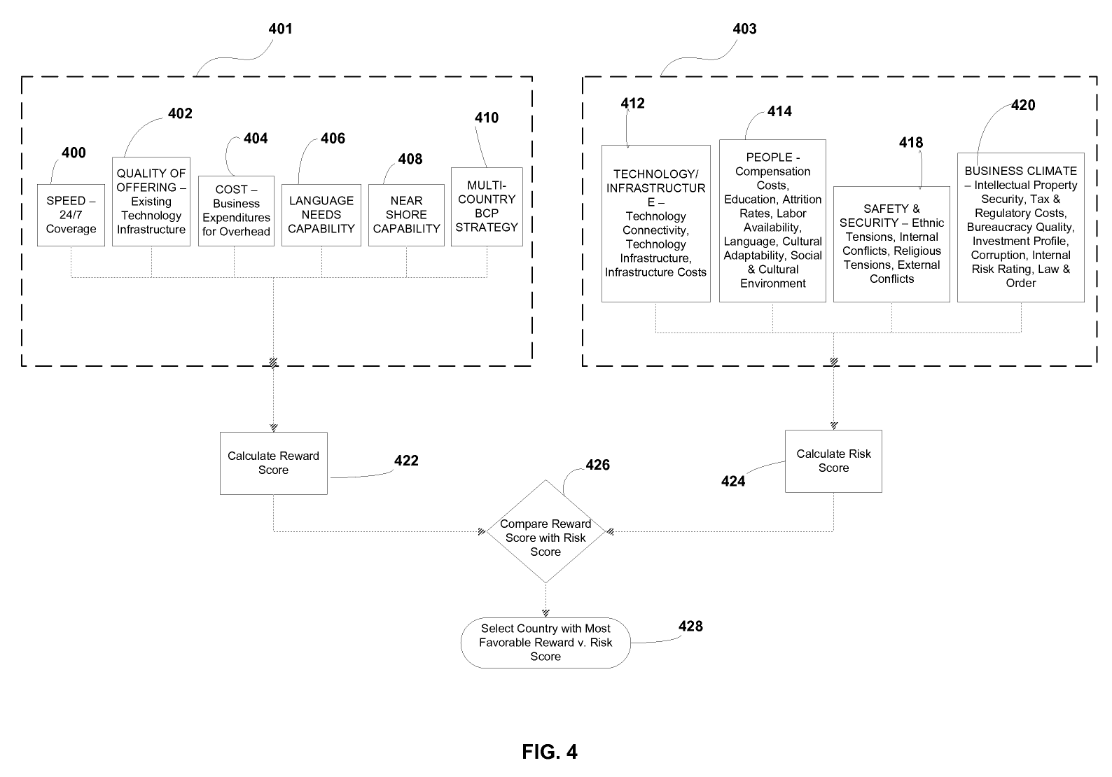

A geographic model may be generated for each country within a group of countries based on the needs and goals of a line of business. The geographic model may be based on one or more categories, as shown in FIG. 4. The categories may vary based on the line of business' needs or goals. The categories may change if the needs or goals change and/or if a different line of business becomes involved in the operations.

FIG. 4 illustrates a plurality of categories that have been organized into two groups, risk factors 403 and reward drivers 401. The categories may be organized into any type and number of desirable groups. Additional groups may include, but are not limited to, a business logic element and a forward looking element (not shown).

The business logic element may include historical corporate experience with the country, connection to other business strategies of another line of business, and current corporate presence in a country or region. The forward looking element may include historical perspectives and future predictions on the country's characteristics. A line of business may assess a country for relocation at a future date. The forward looking element may provide information on a country that is emerging, but not yet mature. An emerging country may not produce favorable reward and risk scores and may otherwise be overlooked.

Referring again to FIG. 4, the geographic model may include reward drivers 401 and risk factors 403. The reward drivers 401 may include speed 400, quality of offering 402, cost 404, language needs capability 406, near shore capability 408, and multi-country Business Continuity Plan (BCP) strategy 410. Speed 400 may consider the time zone in which the country is positioned and may consider whether the work force is active during the usual hours of operation for a line of business. Quality of offering 402 may include the country quality including such factors as the existing information technology and Business Process Outsourcing (BPO) market size, the contact centers and information technology quality rankings, and quality rankings of management and information technology training.

Cost 404 may include rate exposures and business expenditures for overhead such as average wages and median compensation costs for relevant positions such as call center representatives, information technology programmers, and local operations managers. Language needs capability 406 may consider the language skills of the work force including, but not limited to, English, Spanish, and Japanese. Near shore capability 408 may include information relating to the hours of operation of the country's work force, e.g., whether the work force is active during peak business hours. Multi-country BCP strategy 410 may consider whether the country represents a viable location for BCP of India-centric Global Delivery operations.

Multi-country BCP strategy 410 includes any desired strategy to diversify risk to a line of business during a country assessment. In the example described above, a viable location for BCP of India-centric Global Delivery operations may include a country that may assist a line of business in maintaining stable operations during a disaster or crisis. For example, a multi-country BCP strategy 410 may identify the Philippines as a viable country in which to diversity risk for a line of business that has recently relocated to India. The line of business may identify the Philippines as an excellent country from which to base its operations in the event that a disaster, such as a natural disaster or an outbreak of violence, occurs in India and interrupts the operations of the line of business in India.

Additional groups and factors with each group may be used to highlight key reward drivers 401 that may relate to the line of business.

The risk factors 403 may include technology/infrastructure 412, people 414, safety and security 418, and business climate 420. Any other desired risk factors may be considered. The technology/infrastructure 412 may include connectivity, country infrastructure, infrastructure costs, and the like. Connectivity considers the narrowband and broadband penetration, mobile phone penetration, Internet penetration, personal computer penetration, WiFi hotspot penetration, Internet affordability, security of the Internet infrastructure, and any other technology/infrastructure-related considerations. Country infrastructure considers the quality of the infrastructure in areas such as telecommunications and information technology services. Infrastructure costs consider the occupancy, utility, and telecommunication costs of a new location, along with the costs of traveling to major customer destinations.

People 414 includes compensation costs, education of the work force, attrition rates, labor availability, language concerns, cultural adaptability, and social and cultural environments. Compensation costs may consider the average wages and median compensation of the local work force. Education costs may consider standardized education tests that determine whether the local work force is capable of being trained in the needed skill set and/or whether personnel will need to be transplanted from a remote location. Education costs may also consider the costs associated with necessary training and continued education of the work force.

Attrition rates may relate to the relative Information Technology Outsourcing (ITO) and BPO growth and unemployment rates. Labor availability may consider the total work force and the education levels of the work force. For example, the percentage of high school graduates, college graduates, and post-graduates may be considered.

Language may consider the scores that the work force has obtained on standardized language exams or other language testing. Cultural adaptability may consider the scores that a work force may receive on a standardized personal interaction test or other testing associated with determining whether the relocation option and the home location may be compatible. Social and cultural environment may consider the education level, ability to be trained, literacy of the Internet and other computer skills, degree of entrepreneurship, technical skills, and degree of innovation of the work force.

Safety and security 418 may include ethnic tensions, internal conflicts, religious tensions, external conflicts, and the like. Ethnic tensions may analyze the degree of tension within a country that is attributable to race, nationality, or language. Internal conflict may include information on the political violence in the country and its actual or potential impact on government. Internal conflict may include acts such as civil war, coup threats, terrorist activity, political violence, and/or civil disorder.

Religious tensions may consider whether the country imposes undesirable policies such as civil dissent that may disintegrate into civil war and unacceptable civil rights policies. Religious tensions may also consider the potential for a religious group to obtain power of the government or to replace civil law with religious law. External conflicts may consider the risk to the incumbent government of foreign action, ranging from non-violent external pressure such as diplomatic pressures, withholding of aid, trade restrictions, territorial disputes, sanctions, and the like, to violent external pressure such as cross-border conflicts and war.

The risk factors 403 may also include information relating to the business climate of the country 420. The business climate 420 may include intellectual property security, tax and regulatory costs, bureaucracy quality, investment profile, corruption, internal risk rating, and civil and criminal law and order. The intellectual property security may consider investor ratings of intellectual property protection and Internet and Communication Technology (ICT) laws and software piracy rates. Tax and regulatory costs may include information on tax burden, costs of corruption, fluctuating exchange rates, and the like. Bureaucracy quality may include the institutional strength and quality of the bureaucracy that is necessary to govern the country without experiencing drastic changes in policy or interruptions in government services.

Investment profile may consider the risk to foreign and domestic investments such as contract viability and exportation, profits repatriation, and payment delays. Corruption in the political system may also be considered such as excessive patronage, nepotism, job reservations, ‘favors-for-favors’, secret party funding, and suspiciously close ties between politics and business.

The internal risk rating may consider the specific needs of the line of business and any factors that may affect the specific needs and that may be a risk to the line of business. The internal risk rating also may consider external ratings on long-term foreign currency and the Interagency Country Exposure Review ratings. The law and order factors may include an assessment of the strength and impartiality of the legal system and the popular observance of the law.

A reward score may be calculated that is based on the reward drivers and any other reward considerations at step 422. A risk score may be calculated that is based on the risk factors and any other risk consideration at step 424. The reward score and the risk score may be compared at step 426. The country having the most favorable reward score compared to the risk score may be selected as a relocation option, as illustrated in step 428.

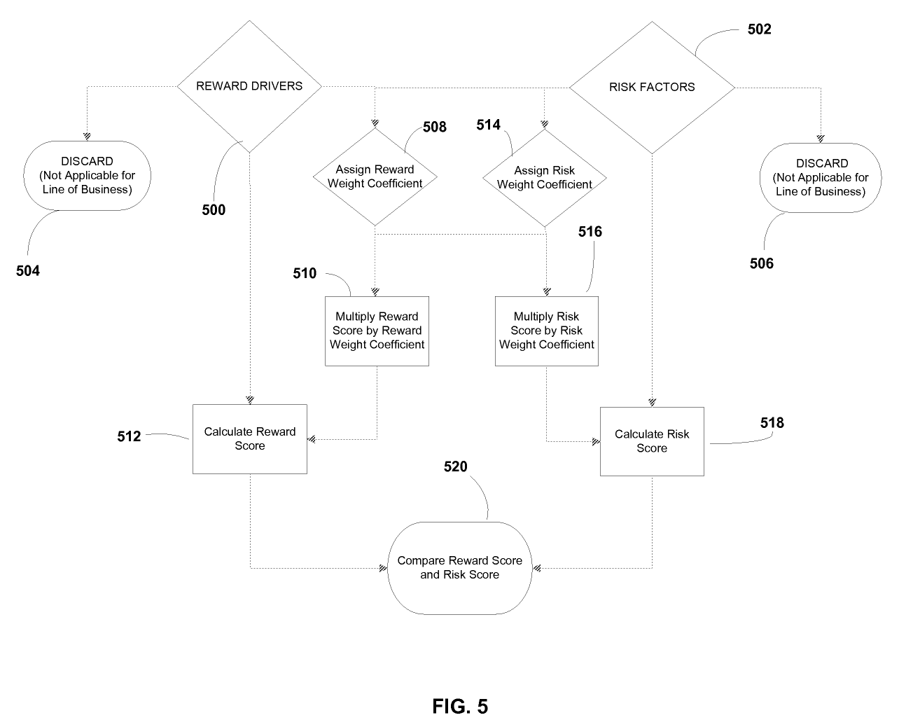

FIG. 5 illustrates a method of comparing the reward score and the risk score. The reward drivers and the risk factors may be identified at steps 500 and 502, respectively. The reward drivers that are not applicable or important to the line of business may be discarded, as illustrated in step 504. The risk factors that are not applicable or important to the line of business may be discarded, as illustrated in step 506.

A reward score and a risk score may be calculated in steps 512 and 518, respectively. A reward weight coefficient may be assigned in step 508. The reward weight coefficient and the reward score may be multiplied in step 510 to calculate a reward score, as in step 516. The reward score may also be calculated without considering a reward weight coefficient.

A risk score may be calculated in step 518. A risk weight coefficient may be assigned in step 514. The risk weight coefficient and the risk score may be multiplied in step 516 to calculate a risk score, as in step 524. The risk score may also be calculated without considering a reward coefficient. The risk score may be compared to the reward score in step 526.

For example, the geographic model may include a group of risk factors and a group of reward drivers. One or more of the reward drivers may be identified as being more important than the other reward drivers. Each selected reward driver may be assigned a reward weight coefficient that is based on the reward driver's level of importance to the line of business. In some examples, the reward drivers may be ranked in a hierarchical fashion and may be assigned a reward driver coefficient based on the reward driver's ranking in the hierarchy. More critical reward drivers may be assigned a large reward driver coefficient. A reward driver with less importance may be assigned a small reward driver coefficient or a reward driver coefficient of zero.

Similarly, one or more of the risk factors may be identified as being more important than the other risk factors. Each selected risk factor may be assigned a risk weight coefficient that is based on the risk factor's level of importance to the line of business. In some examples, the risk factors may be ranked in a hierarchical fashion and may be assigned a risk factor coefficient based on the risk factor's ranking in the hierarchy. More critical risk factors may be assigned a large risk factor coefficient, whereas less important risk factors may be assigned a low value or a zero value.

For example, a line of business may assign a reward weight coefficient of 0.80 or 80% to the ability of the work force to speak English and Spanish. The reward score calculated for the ability of the work force to speak English and Spanish will be multiplied by 0.80. As a secondary consideration, the line of business may choose to assign a reward coefficient of 0.20 or 20% to the costs associated with supporting a bilingual work force. The reward score calculated for the costs associated with supporting a bilingual work force will be multiplied by 0.20. In this example, no additional reward drivers are being considered. A weight coefficient may be assigned to any desired number of reward drivers and/or risk factors.

Aspects of the invention have been described in terms of illustrative embodiments thereof. Numerous other embodiments, modifications, and variations are within the scope and spirit of the appended claims. For example, the steps illustrated in the figures may be performed in other than the recited order, and that one or more steps illustrated may be optional in accordance with aspects of the disclosure. Of course, the methods and systems of the above-referenced embodiments may also include other additional elements, steps, computer-executable instructions, or computer-readable data structures. In this regard, other embodiments are disclosed herein that can be partially or wholly implemented on a computer-readable medium, for example, by storing computer-executable instructions or modules, or by utilizing computer-readable data structures.

We claim:

1. A method, comprising:
selecting a country;
analyzing country data relating to the country;
generating at least one category relating to the country;
generating a reward score for the country based at least in part on the country data and the at least one category; and
generating a risk score for the country based at least in part on country data and the at least one category.

2. The method of claim 1, further comprising generating a geographic model based at least in part of the reward score and the risk score.

3. The method of claim 2, where the generating a geographic model is electrically generated.

4. The method of claim 3, where the generating the generating the geographic model is accessible over a computer network.

5. The method of claim 1, where the country is selected from a plurality of countries.

6. The method of claim 1, where the country data includes data from an internal perspective.

7. The method of claim 1, where the country data includes data from an external perspective.

8. The method of claim 1 where the at least one category includes at least one of speed, quality of offering, cost, language needs capability, near shore capability, multi-country BCP strategy, technology and infrastructure, people, safety and security, and business climate.

9. The method of claim 1, further comprising comparing the reward score and the risk score.

10. The method of claim 1, further comprising selecting a country for an in-country/due diligence visit.

11. The method of claim 1, further comprising assembling a risk mitigation framework.

12. The method of claim 1, further comprising assigning a reward weight coefficient.

13. The method of claim 1, where a risk weight coefficient is assigned to the risk score.

14. A method of assessing a country, comprising:
identifying at least one country;
generating a geographic model of the at least one country;
conducting an in-country/due diligence visit based at least in part on the geographic model;
assemble a risk mitigation framework based at least in part on the geographic model and the in-country/due diligence visit; and
selecting a relocation option based on the geographic model, the in-country/due diligence visit, and the risk mitigation framework.

15. The method of claim 14, where the geographic model is assembled at least partially over a computer network.

16. The method of claim 14, where the country is selected from a plurality of countries.

17. The method of claim 14, where the generating the geographic model comprises:
selecting at least one country;
analyzing country data relating to the country;
generating at least one category relating to the country;
generating a reward score for the country based at least in part on the country data and the at least one category; and
generating a risk score for the country based at least in part on the country data and the at least one category.

18. The method of claim 17, where the at least one category includes at least one of speed, quality of offering, cost, language needs capability, near shore capability, multi-country BCP strategy, technology and infrastructure, people, safety and security, and business climate.

19. The method of claim 14, further comprising comparing the reward score and the risk score.

20. The method of claim 14, further comprising assigning a reward weight coefficient.

21. The method of claim 14, further comprising assigning a risk weight coefficient.

22. A computer-readable medium comprising computer-executable instructions to perform a method, comprising:
selecting a country;
analyzing country data relating to the country;
generating at least one category relating to the country;
generating a reward score for the country based at least in part on the country data and the at least one category; and
generating a risk score for the country based at least in part on country data and the at least one category.

23. An apparatus for generating a geographic model, comprising:
a memory storing a plurality of modules comprising computer-executable instructions, the plurality of modules including:
a country data module configured to store country data relating to the country;
a category module configured to identify categories on which to assess the country;
a reward module configured to calculate a reward score based at least in part on the country data and the categories;
a risk module configured to calculate a risk score based at least in part on the country data and the categories;
a comparison module configured to compare the reward score and the risk score; and
a processor configured to execute the computer-executable instructions in the plurality of modules to generate the geographic model based at least in part on the reward score and the risk score.
